(19) United States
(12) Patent Application Publication
(10) Pub. No.: US 2024/0222713 A1
(43) Pub. Date: Jul. 4, 2024

(54) BATTERY PACK AND METHOD OF MANUFACTURING THE SAME

(71) Applicant: SAMSUNG SDI CO., LTD., Yongin-si (KR)

(72) Inventor: Daehyeong YOO, Yongin-si (KR)

(21) Appl. No.: 18/201,858

(22) Filed: May 25, 2023

(30) Foreign Application Priority Data
Dec. 29, 2022 (KR) 10-2022-0189733

(51) Int. Cl. H01M 10/42; H01M 10/04; H01M 50/536

(52) U.S. Cl. CPC H01M 10/425; H01M 10/049; H01M 50/536

(57) ABSTRACT

A battery pack comprising a case, an electrode assembly accommodated in the case and including an electrode tab, and a protection circuit including a substrate tab connected to the electrode tab, wherein the substrate tab includes, a first support on a top surface of the protection circuit, a second support bendable with respect to the first support to cooperatively hold the electrode tab between the first support and the second support, and a guide portion guiding a bending position of the second support.

### CROSS-REFERENCE TO RELATED APPLICATIONS

Korean Patent Application No. 10-2022-0189733, filed on Dec. 29, 2022, in the Korean Intellectual Property Office, is incorporated by reference herein in its entirety.

### BACKGROUND

### 1. Field

A battery pack and a method of manufacturing the same is disclosed.

### 2. Description of the Related Art

Battery packs generally include an electrode assembly including a cathode, an anode, and a separator, and a case accommodating the electrode assembly, in spite of some differences depending on shapes and characteristics thereof.

### SUMMARY

Embodiments are directed to a battery pack including a case, an electrode assembly accommodated in the case and including an electrode tab, and a protection circuit including a substrate tab connected to the electrode tab, wherein the substrate tab includes a first support on a top surface of the protection circuit, a second support bendable with respect to the first support to cooperatively hold the electrode tab between the first support and the second support, and a guide portion guiding a bending position of the second support.

In the battery pack according to an embodiment, the guide portion includes a protruding portion in any one of the first support and the second support and an accommodating portion in the other of the first support and the second support to accommodate the protruding portion.

In the battery pack according to an embodiment, the accommodating portion is recessed concavely on an inner side of the second support such that the protruding portion is not exposed to the outside in a state of being inserted into the accommodating portion.

In the battery pack according to an embodiment, a top surface of the protruding portion is exposed through the second support and where the protruding portion is inserted into the accommodating portion.

In the battery pack according to an embodiment, the protruding portion includes a proximal portion extending from the first support and a distal portion exposed through the second support and having an area greater than an area of the proximal portion.

In the battery pack according to an embodiment, the distal portion has an area greater than an area of the accommodating portion.

In the battery pack according to an embodiment, at least a part of the distal portion contacts a top surface of the second support in a state where the distal portion is forcedly inserted into the accommodating portion.

In the battery pack according to an embodiment, the first support includes a first region where the electrode tab is arranged and a second region arranged outside the first region and in which the protruding portion is formed, and the accommodating portion is outside the second support to correspond to the protruding portion.

In the battery pack according to an embodiment, the protruding portion includes a plurality of protruding portions which is separated from one another.

In the battery pack according to an embodiment, the first support includes a third region arranged inside the second region adjacent to the second support, and the protruding portion is in the third region.

In the battery pack according to an embodiment, the protruding portion protrudes above the electrode tab placed on the first support.

In the battery pack according to an embodiment, the support tab further includes a notch portion between the first support and the second support to include a boundary between the first support and the second support.

In the battery pack according to an embodiment, the protection circuit includes a nesting groove formed recessed in a top surface thereof such that the first support is placed in the nesting groove.

According to one or more embodiments, a method of manufacturing a battery pack includes arranging an electrode assembly including an electrode tab on an inner space of a case, arranging the electrode tab on a substrate tab of a protection circuit, bending the substrate tab such that guide portions respectively formed on a side and another side of the substrate tab correspond to each other, so as to cooperatively hold the electrode with the substrate tab, and welding the electrode tab and the substrate tab to each other.

In the method according to an embodiment, the substrate tab includes a first support placed on the protection circuit and a second support bendable with respect to the first support, the guide portion includes a protruding portion on the first support and an accommodating portion on the second support to correspond to the protruding portion, and the bending of the substrate tab includes determining a position of the second support and bending the substrate tab such that the protruding portion is accommodated in the accommodating portion.

In the method according to an embodiment, the welding includes performing welding on a region where the first support, the electrode tab, and the second support overlap one another.

In the method according to an embodiment, the substrate tab further includes a notch portion having a boundary between the first support and the second support, and the bending of the substrate tab includes bending the substrate tab such that north portions respectively formed on the first support and the second support overlap each other.

In the method according to an embodiment, the welding includes laser welding.

### BRIEF DESCRIPTION OF THE DRAWINGS

Features will become apparent to those of skill in the art by describing in detail exemplary embodiments with reference to the attached drawings in which:

FIG. 1 shows a coupling state between an electrode assembly and a case according to an example embodiment.

FIG. 2 shows a state where a battery pack is assembled according to an example embodiment.

FIG. 3 shows a coupling state between an electrode assembly and a protection circuit according to an example embodiment.

FIG. 4 shows a substrate tab according to an example embodiment.

FIGS. 5 and 6 show an operation where an electrode assembly is coupled to a protection circuit, according to an example embodiment.

FIG. 7 shows a cross-section taken along a line A-A of FIG. 6.

FIG. 8 shows a cross-section of a protection circuit according to another example embodiment.

FIG. 9 shows a cross-section of a protection circuit according to another example embodiment.

FIG. 10 shows a cross-section of a protection circuit according to another example embodiment.

FIG. 11 shows a substrate tab according to another example embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure may have various modifications thereto and various embodiments, and thus particular embodiments will be illustrated in the drawings and described in detail in a detailed description. It should be understood, however, that this is not intended to limit the disclosure to a particular embodiment of the disclosure, and should be understood to include all changes, equivalents, and alternatives falling within the spirit and scope of the disclosure. To describe the disclosure, the same component, even when shown in different embodiments, will be denoted by the same reference numeral.

Hereinafter, embodiments of the disclosure will be described in detail with reference to the accompanying drawings, and in description with reference to the drawings, the same or corresponding components are given the same reference numerals, and redundant description thereto will be omitted.

In the following embodiments, the terms first, second, etc., have been used to distinguish one component from other components, rather than limiting.

In the following embodiment, singular forms include plural forms unless apparently indicated otherwise contextually.

In the following embodiments, the terms “include”, “have”, or the like, are intended to mean that there are features, or components, described herein, but do not preclude the possibility of adding one or more other features or components.

In the drawings, the size of components may be exaggerated or reduced for convenience of description. In an implementation, the size and thickness of each component shown in the drawings are shown for convenience of description, and thus the disclosure is not necessarily limited to the illustration.

In the following embodiment, an x-axis, a y-axis, and a z-axis are not limited to three axes on an orthogonal coordinate system, and may be interpreted in a broad sense including them. In an implementation, the x-axis, the y-axis, and the z-axis may be orthogonal to each other, but may also refer to different directions that are not orthogonal to each other.

When a certain embodiment may be implemented otherwise, a particular process order may be performed differently from the order described. In an implementation, two processes described in succession may be performed substantially simultaneously, or may be performed in an order reverse to the order described.

The term used herein is used to describe particular embodiments, and is not intended to limit the disclosure. Moreover, it should be understood that the term “include”, “have”, or the like used herein is to indicate the presence of features, numbers, steps, operations, elements, parts, or a combination thereof described in the specifications, and does not preclude the presence or addition of one or more other features, numbers, steps, operations, elements, parts, or a combination thereof.

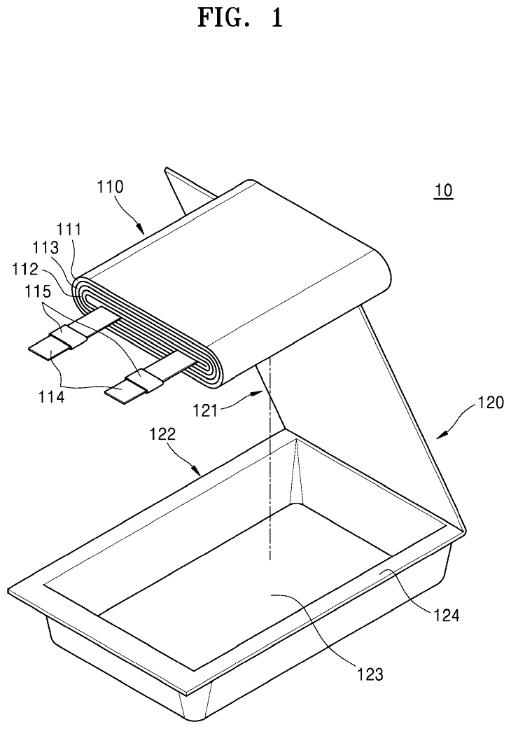

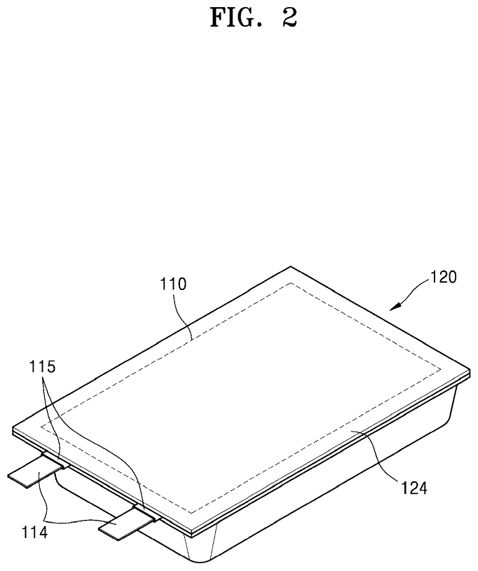

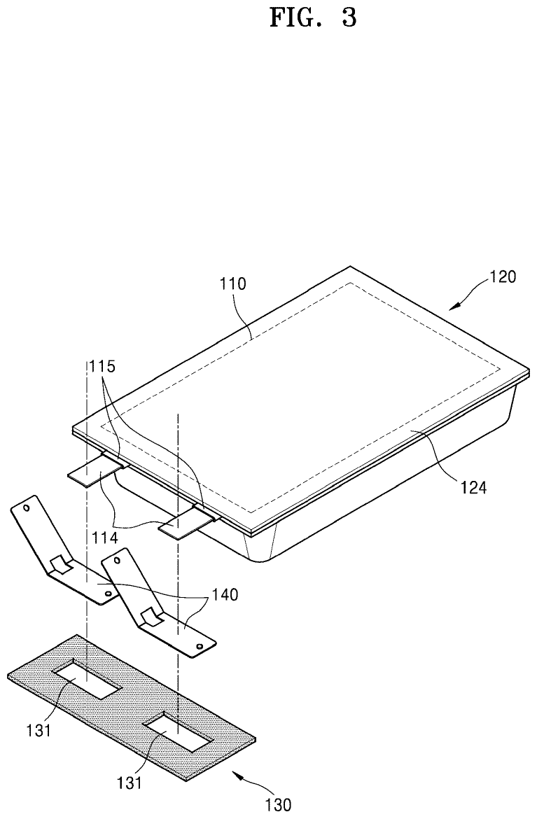

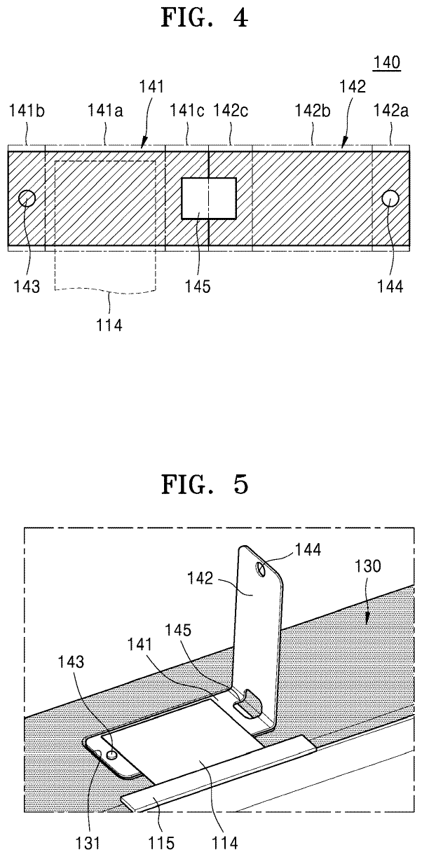

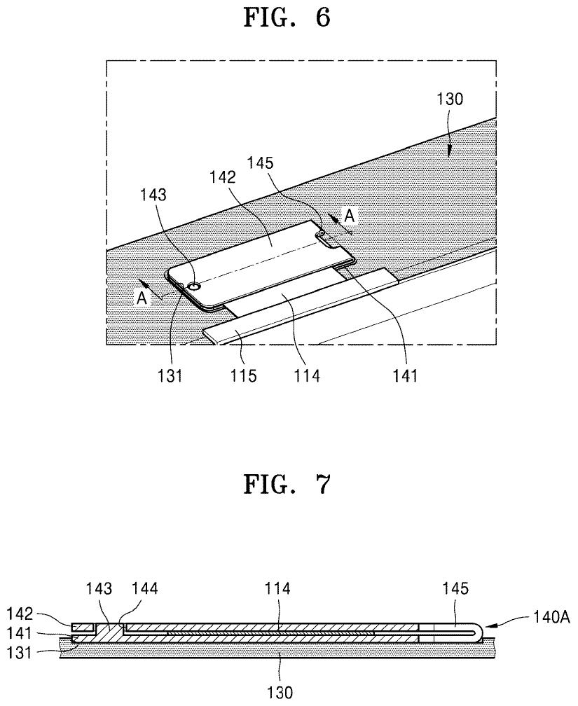

FIG. 1 shows a coupling state between an electrode assembly 110 and a case 120 according to an example embodiment, FIG. 2 shows a state where a battery pack 10 is assembled according to an example embodiment, FIG. 3 shows a coupling state between the electrode assembly 110 and a protection circuit 130 according to an example embodiment, FIG. 4 shows a substrate tab 140 according to an example embodiment, FIGS. 5 and 6 show an operation where the electrode assembly 110 is coupled to the protection circuit 130 according to an example embodiment, and FIG. 7 shows a cross-section taken along a line A-A of FIG. 6.

Referring to FIGS. 1 to 7, the battery pack 10 according to an embodiment may be applied to a laptop as a pouch-type secondary battery. Alternatively, the battery pack 10 may be applied to a tablet personal computer (PC), a smart phone, or a vehicle battery, as a can-type or cylindrical secondary battery. As used herein, the term “or” is not an exclusive term, e.g., “A or B” would include A, B, or A and B.

The battery pack 10 may include the electrode assembly 110, the case 120, and the protection circuit 130. The electrode assembly 110 may be manufactured in the form of a jelly roll by winding a separator 113 between a first electrode plate 111 and a second electrode plate 112. Alternatively, the electrode assembly 110 may be manufactured in the form of a stack by stacking the separator 113 between a plurality of first electrode plates 111 and second electrode plates 112. The electrode assembly 110 may be manufactured by applying both a jelly roll and a stack.

The first electrode plate 111 may include a first active material coating portion intermittently coating a first active material onto a first base that may be a conductive material in the form of a sheet and a first uncoated portion in which the first base is exposed because the first active material may not be coated thereon. In an implementation, the first electrode plate 111 may be a negative electrode plate, and the first active material may be a negative electrode active material including carbon materials such as crystalline carbon, amorphous carbon, carbon composites, carbon fibers, lithium metal, or lithium alloys.

The second electrode plate 112 may have a polarity that is different from that of the first electrode plate 111, and may include a second active material coating portion intermittently coating a second active material onto a second base that may be a conductive material in the form of a sheet, and a second uncoated portion in which the second base is exposed because the second active material may not be coated thereon. In an implementation, the second electrode plate 112 may be a positive electrode plate, and the second active material may include a positive electrode active material including lithium such as LiCoO₂, LiNiO₂, LiMnO₂, LiMn₂O₄, or LiNi_{1-x-y}CoₓM_{y}O₂.

The separator 113 may be between the first electrode plate 111 and the second electrode plate 112. The separator 113 may insulate the first electrode plate 111 from the second electrode plate 112 and exchange lithium ions between the first electrode plate 111 and the second electrode plate 112. The separator 113 may have a length enough to completely insulate the first electrode plate 111 from the second electrode plate 112 even when the electrode assembly 110 contracts or expands in a process of charging and discharging the battery pack 10.

The electrode tab 114 may be in each of the first electrode plate 111 and the second electrode plate 112 to protrude to a side. In an implementation, the electrode tabs 114 may be arranged in pairs to correspond to the first electrode plate 111 and the second electrode plate 112. More specifically, the electrode tab 114 may be electrically connected to a side of the first uncoated portion of the first electrode plate 111 to extend toward an outside of the electrode assembly 110. In addition, the electrode tab 114 may be electrically connected to a side of the second uncoated portion of the second electrode plate 112 to extend toward the outside of the electrode assembly 110.

A film portion 115 may be in the electrode tab 114. The film portion 115 may be on a surface of the electrode tab 114 or to surround the electrode tab 114. The film portion 115 may seal the electrode tab 114 exposed to the outside of the electrode assembly 110. In an implementation, to prevent a short-circuit from occurring due to contact of the electrode tab 114 with a metal layer exposed in an end portion of a sealing portion 124 of the case 120 to be described later, the film portion 115 may be thermally fused with the sealing portion 124 to closely couple the electrode tab 114 to the sealing portion 124.

The case 120 may form an exterior of the battery pack 10, and the electrode assembly 110 may be arranged therein. A shape and a size of the case 120 may correspond to those of the electrode assembly 110. In an implementation, as shown in FIG. 1, the case 120 may have a hollow cuboid shape. In addition, the case 120 may have a polyhedron in another shape or a cylindrical shape.

The case 120 may include a cover 121, a lower case 122, an inner space 123, and the sealing portion 124.

The lower case 122 may include the inner space 123 having larger dimensions than those of the electrode assembly 110, and the electrode assembly 110 may be inserted into the inner space 123. The cover 121 may be on a top surface of the lower case 122 to be openable such that the cover 121 may cover the electrode assembly 110 in a state where the electrode assembly 110 is inserted into the inner space 123.

The sealing portion 124 may be arranged along a top edge of the lower case 122. As shown in FIG. 2, in a state where the electrode assembly 110 is accommodated in the case 120, a part of the electrode tab 114 may be exposed to an outside of the case 120. The film portion 115 in the electrode tab 114 may be between the cover 121 and the lower case 122 in a position corresponding to the sealing portion 124.

The protection circuit 130 may include an electric circuit and various elements to prevent overcharge, overdischarge, overcurrent, and short-circuit of the battery pack 10, more specifically, the electrode assembly 110. As shown in FIG. 3, the protection circuit 130 may be on an outer side of the case 120 and may be connected to the electrode tab 114.

In an embodiment, the protection circuit 130 may have a plate shape to support a pair of electrode tabs 114.

In an embodiment, the protection circuit 130 may further include a nesting groove 131. The nesting groove 131 may be a groove recessed inward to form a step with a top surface of the protection circuit 130, and the substrate tab 140 may be placed in the nesting groove 131. In an embodiment, the nesting groove 131 may have a depth lower than a thickness of the substrate tab 140. Thus, as shown in FIG. 7, as a top surface of a first support 141 is above a top surface of the protection circuit 130 in a state where the substrate tab 140 is placed in the nesting groove 131, the electrode tab 114 may be stably on the first support 141.

In an embodiment, the protection circuit 130 may include the substrate tab 140.

The substrate tab 140 may be on the protection circuit 130 to support the electrode tab 114, thereby connecting the electrode assembly 110 to the protection circuit 130. In an implementation, as shown in FIGS. 5 and 6, when the electrode tab 114 is on a side of the substrate tab 140 in a state where the substrate tab 140 is on the top surface of the protection circuit 130, the substrate tab 140 may be bent toward the electrode tab 114 to cooperatively hold the electrode tab 114. In this state, by performing welding between the protection circuit 130 and the electrode tab 114, welding may be performed at an exact position.

In an embodiment, the substrate tab 140 may include the first support 141 and a second support 142.

The first support 141 may be on the top surface of the protection circuit 130 on which the electrode tab 114 may be arranged. In an implementation, the first support 141 may be inserted into the nesting groove 131 of the protection circuit 130, and on a top surface of the first support 141, the electrode tab 114 may be arranged.

The second support 142 may extend from an end of the first support 141, and may be bent or unbent with respect to the first support 141. As shown in FIGS. 5 and 6, in a state where the first support 141 is inserted into the nesting groove 131 and the electrode tab 114 is on the first support 141, the second support 142 may be opened outward with respect to the first support 141. Thereafter, the second support 142 may be bent with respect to the first support 141 to support the electrode tab 114. As such, the electrode tab 114 and the protection circuit 130 may be stably connected through the substrate tab 140 including the bendable first support 141 and second support 142, and in this state, triple-layer welding may be performed stably.

In an embodiment, the substrate tab 140 may include a guide portion.

The guide portion may be a member for guiding a position of the second support 142 when the second support 142 is bent toward the first support 141. In an implementation, in a state where the second support 142 is bent to contact the first support 141, the guide portion may maintain the position of the second support 142 to prevent the second support 142 from being unbent again. Alternatively, the guide portion may guide a position at which the second support 142 is bent with respect to the first support 141.

In an embodiment, the guide portion may include a protruding portion 143 and an accommodating portion 144.

The protruding portion 143 may be in any one of the first support 141 and the second support 142, and the accommodating portion 144 may be in the other. In an implementation, as shown in FIGS. 4 to 6, the protruding portion 143 may protrude on the top surface of the first support 141. It is shown in the drawing that the protruding portion 143 may have a cylindrical shape, but the protruding portion 143 may have a polyhedral shape, a convex top shape, or a tapered shape in a height direction. In the current embodiment, the protruding portion 143 may have a cylindrical shape. The protruding portion 143 may be at a position opposing the second support 142 with respect to a position at which the electrode tab 114 may be arranged.

In an embodiment, the protruding portion 143 may protrude above the electrode tab 114 placed on the first support 141. That is, as shown in FIG. 7, a top surface of the protruding portion 143 may be located higher than a top surface of the electrode tab 114. Thus, the accommodating portion 144 may be stably coupled to the protruding portion 143 in a state where the electrode tab 114 may be inserted between the first support 141 and the second support 142.

The accommodating portion 144 may be in the second support 142 and may have a shape and a size corresponding to the protruding portion 143. The accommodating portion 144 may be a hole or a groove into which the protruding portion 143 may be inserted and may be on an outer side of the second support 142. In the current embodiment, the accommodating portion 144 may be a hole penetrating the second support 142. Thus, as the second support 142 is bent toward the first support 141, the protruding portion 143 may be inserted into the accommodating portion 144, thereby stably maintaining a bending state. When the bending position is misaligned, the second support 142 may be lifted relative to the first support 141, allowing an operator to easily identify and modify a bending state.

More specifically, as shown in FIG. 7, the electrode tab 114 and the substrate tab 140 may be on the protection circuit 130. The first support 141 of the substrate tab 140 may be placed in the nesting groove 131, and the electrode tab 114 may be on the top surface of the first support 141. The second support 142 may be bent toward the first support 141 and the protruding portion 143 may be accommodated in the accommodating portion 144, thus forming triple layers of the first support 141—the electrode tab 114—the second support 142. In this state, the operator may perform welding (e.g., laser welding) on a top surface of the second support 142.

In an embodiment, in a state where the protruding portion 143 is inserted into the accommodating portion 144, the top surface of the protruding portion 143 may be exposed through the second support 142. As shown in FIGS. 6 and 7, when the second support 142 is bent toward the first support 141, the protruding portion 143 may be accommodated in the accommodating portion 144 and the top surface of the protruding portion 143 may be exposed to an outside through the accommodating portion 144 perforated in the second support 142. In this way, the operator may easily identify whether the second support 142 is bent at a right position relative to the first support 141.

In an embodiment, the first support 141 may include a first support region 141a and a first coupling region 141b.

As shown in FIG. 4, the first support region 141a may be in an inner longitudinal direction of the first support 141. The first support region 141a may have a greater width than the electrode tab 114, and directly contact the electrode tab 114. The first coupling region 141b may be on an outer side of the first support 141 adjacent to the first support region 141a. The first coupling region 141b may be a region where the first support 141 is coupled to the second support 142, and the protruding portion 143 may be inside the first coupling region 141b.

In this way, the electrode tab 114 may be on the first support region 141a and the protruding portion 143 may be on the first coupling region 141b, such that the electrode tab 114 and the protruding portion 143 may be surely separated from each other. Thus, it may be surely possible to prevent the electrode tab 114 from interfering with the protruding portion 143 or the accommodating portion 144 in a bending process of the substrate tab 140.

In an embodiment, the second support 142 may include a second support region 142a and a second coupling region 142b.

As shown in FIG. 4, the second support region 142a may be in an inner longitudinal direction of the second support 142. The second support region 142a may have a greater width than the electrode tab 114, and may be at a position corresponding to the first support region 141a. In a state where the second support 142 is bent, the second support region 142a may cooperatively hold the electrode tab 114 together with the first support region 141a.

The second coupling region 142b may be outside the second support 142 adjacent to the second support region 142a. The second coupling region 142b may be a region where the second support 142 is coupled to the first support 141, and the accommodating portion 144 may be inside the second coupling region 142b.

In an embodiment, the first support 141 and the second support 142 may respectively include a first bending region 141c and a second bending region 142c. As shown in FIG. 4, the first bending region 141c may be inside the first support 141 and the second bending region 142c may be inside the second support 142 in adjacent to the first bending region 141c. At least parts of the first bending region 141c and the second bending region 142c may be bent when the second support 142 is bent toward the first support 141, such that ends thereof may be convexly bent outward.

In an embodiment, the substrate tab 140 may further include a notch portion 145.

As shown in FIGS. 4 to 6, the notch portion 145 may be inside the substrate tab 140, e.g., between the first support 141 and the second support 142. The notch portion 145 may include a boundary between the first support 141 and the second support 142, and may be inside edges of the first support 141 and the second support 142. The notch portion 145 may include at least parts of the first support 141 and the second support 142, enabling the second support 142 to be more easily bent.

In an embodiment, the north portion 145 may be between the first bending region 141c and the second bending region 142c.

In an embodiment, in a state where the second support 142 is bent onto the first support 141, the notch portion 145 may be arranged such that the notch portion 145 on the first support 141 and the notch portion 145 on the second support 142 overlap each other. More specifically, as shown in FIGS. 6 and 7. in a state where the second support 142 is bent parallel to the first support 141, the north portion 145 on the first support 141 and the notch portion 145 on the second support 142 may at least partially overlap each other, when viewed from a plane. More specifically, in a state where the second support 142 is bent parallel to the first support 141, the notch portion 145 on the first support 141 and the notch portion 145 on the second support 142 may completely match each other.

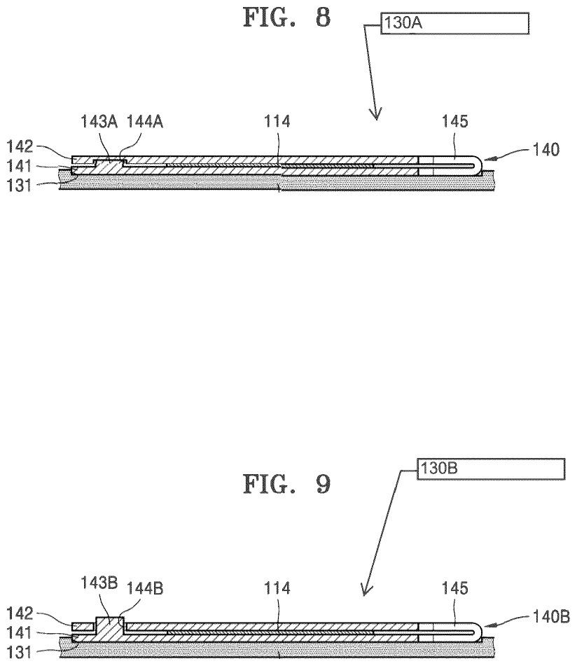

FIG. 8 shows a cross-section of a protection circuit 130A according to another example embodiment. The protection circuit 130A shown in FIG. 8 may have different shapes of a protruding portion 143A and an accommodating portion 144A of a substrate tab 140A from those of the protection circuit 130A according to the above-described embodiment, and the other components thereof may be the same as those of the protection circuit 130. Hereinbelow, for convenience, a description will be made mainly of the protruding portion 143A and the accommodating portion 144A.

The substrate tab 140 may include the first support 141, the second support 142, the protruding portion 143A, the accommodating portion 144A, and the notch portion 145.

In an embodiment, the accommodating portion 144A may be a groove concave in a surface of the second support 142. That is, unlike the accommodating portion 144 according to the above-described embodiment, the accommodating portion 144A may be concave in a surface opposing the protruding portion 143A, instead of being perforated in the second support 142. Thus, in a state where the protruding portion 143A and the accommodating portion 144A are coupled, a top surface of the protruding portion 143A may be covered with the accommodating portion 144A.

With such a structure, in a state where the second support 142 is bent onto the first support 141, the protruding portion 143A may not be exposed to the outside through the second support 142. As a result, it may be possible to certainly prevent a top of the protruding portion 143A, exposed to the outside, from interfering with the battery pack 10 and other members.

FIG. 9 shows a cross-section of a protection circuit 130B according to another example embodiment. The protection circuit 130B shown in FIG. 9 have different shapes of a protruding portion 143B and an accommodating portion 144B of a substrate tab 140B from those of the protection circuit 130 according to the above-described embodiment, and the other components thereof may be the same as those of the protection circuit 130. Hereinbelow, for convenience, a description will be made mainly of the protruding portion 143B and the accommodating portion 144B.

The substrate tab 140B may include the first support 141, the second support 142, the protruding portion 143B, the accommodating portion 144B, and the notch portion 145.

In an embodiment, in a state where the protruding portion 143B is accommodated in the accommodating portion 144B, a top of the protruding portion 143B may protrude above the second support 142. That is, as shown in FIG. 9, when the second support 142 is bent onto the first support 141, the protruding portion 143B may be accommodated in the accommodating portion 144b and the top of the protruding portion 143B may be higher than the top surface of the second support 142. In this way, the operator may surely identify the position of the protruding portion 143B with the naked eyes, allowing the operator to easily identify whether the second support 142 is bent to a designated position.

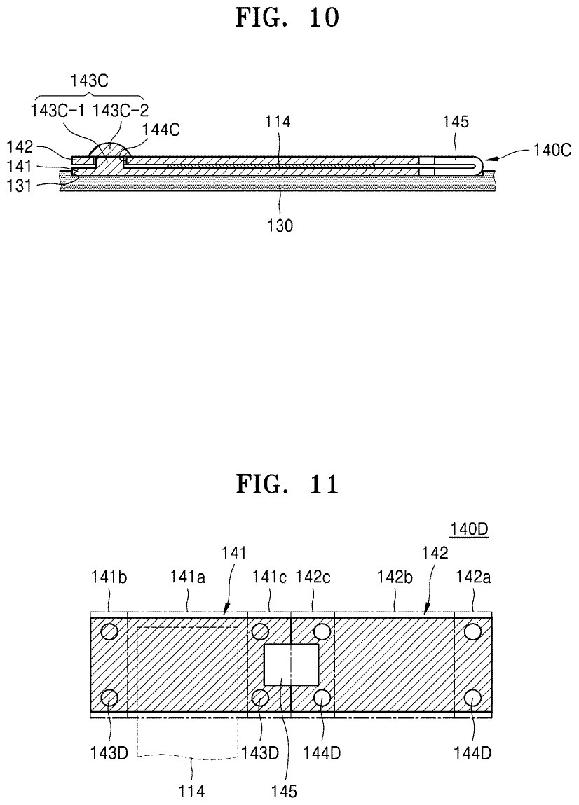

FIG. 10 shows a cross-section of a protection circuit 130C according to another example embodiment. The protection circuit 130C shown in FIG. 10 have different shapes of a protruding portion 143C and an accommodating portion 144C of a substrate tab 140C from those of the protection circuit 130 according to the above-described embodiment, and the other components thereof may be the same as those of the protection circuit 130. Hereinbelow, for convenience, a description will be made mainly of the protruding portion 143C and the accommodating portion 144C.

The substrate tab 140C may include the first support 141, the second support 142, the protruding portion 143C, the accommodating portion 144C, and the notch portion 145.

In an embodiment, the protruding portion 143C may include a proximal portion 143C-1 and a distal portion 143C-2.

The proximal portion 143C-1 may extend from the top surface of the first support 141 and may have a cylindrical shape. In a state where the second support 142 is bent onto the first support 141, a top of the proximal portion 143C-1 may be located at the same height as or lower than a top of the accommodating portion 144C. That is, the top of the proximal portion 143C-1 may be located at the same height as or lower than the top surface of the second support 142.

The distal portion 143C-2 may extend from the top of the proximal portion 143C-1. As shown in FIG. 10, the distal portion 143C-2 may protrude from the top of the proximal portion 143C-1, and a bottom of the second support 142 may contact the top surface of the second support 143 in a bent state of the second support 142. The distal portion 143C-2 may have a greater cross-sectional area than that of the proximal portion 143C-1 and/or the accommodating portion 144C. Thus, when the second support 142 is bent to the first support 141, the distal portion 143C-2 may be forcedly inserted into the accommodating portion 144C. A peripheral edge of the accommodating portion 144C may contact a bottom of the distal portion 143C-2.

With this structure, the second support 142 may be bent toward the first support 141 at an accurate position, and the bent second support 142 may not be unbent to the original state, thereby surely maintaining a position thereof.

It is shown in the drawing that the distal portion 143C-2 may have a semi-spheric shape or a round upper shape. The distal portion 143C-2 may have a greater cross-sectional area than that of the proximal portion 143C-1 and/or the accommodating portion 144C, and may have various shapes. In an implementation, the distal portion 143C-2 may have a polyhedral shape such as a triangular prism, or a quadrangular prism. In an embodiment, the distal portion 143C-2 may have a shape in which a cross-sectional area of the distal portion 143C-2 gradually decreases upwardly from a portion thereof connected to the proximal portion 143C-1. Thus, the second support 142 may be stably inserted into the protruding portion 143C.

FIG. 11 shows a substrate tab 140D according to another example embodiment. For the substrate tab 140D of FIG. 11, shapes of a protruding portion 143D and an accommodating portion 144D may be different from those of the substrate tab 140 according to the above-described embodiment, and the other components may be the same as shoe of the substrate tab 140. Hereinbelow, for convenience, a description will be made mainly of the protruding portion 143D and the accommodating portion 144D.

The substrate tab 140D may include the first support 141, the second support 142, the protruding portion 143D, the accommodating portion 144D, and the notch portion 145. In an embodiment, the protruding portion 143D and the accommodating portion 144D may be in plural respectively on the first support 141 and the second support 142. In an implementation, as shown in FIG. 11, a plurality of protruding portions 143D may be separated from one another in the first coupling region 141b. A plurality of accommodating portions 144D may also be separated from one another in the second coupling region 142b to correspond to the protruding portions 143D. In this way, a bending position of the second support 142 may be certainly guided.

In an embodiment, the protruding portion 143D and the accommodating portion 144D may be in the first notch region 141c and the second notch region 142c. In an implementation, as shown in FIG. 11, the plurality of protruding portions 143D may oppose one another with the notch portion 145 therebetween in the first notch region 141c. The plurality of accommodating portions 144D may oppose one another with the notch portion 145 therebetween in the second notch region 142c. As such, by further arranging the protruding portion 143D and the accommodating portion 144D in the notch region, a coupling state between the first support 141 and the second support 142 may be firmly maintained.

In an embodiment, the plurality of protruding portions 143D and the plurality of accommodating portions 144D may have the same shape or different shapes. In an implementation, some of the plurality of protruding portions 143D may have a cylindrical shape on the first support 141, and may be exposed to an outside through the second support 142 or may be covered with the second support 142 on a top surface thereof in a state of being inserted into the accommodating portion 144D. Alternatively, some of the plurality of protruding portions 143D may include the distal portion 143C-2 like in the above-described embodiment. Each accommodating portion 144D may have a shape corresponding to the protruding portion 143D.

Next, a method of manufacturing the battery pack 10 according to an embodiment will be described with reference to FIGS. 1 to 7.

First, the electrode assembly 110 may be inserted into the case 120. The electrode assembly 110 may be on the lower case 122 of the case 120, and the electrode tab 114 may be exposed to the outside the case 120. The cover 121 may be closed to seal the case 120 along the sealing portion 124.

Next, the electrode tab 114 may be on the substrate tab 140 of the protection circuit 130. The substrate tab 140 may be in a state of being placed in the nesting groove 131 of the protection circuit 130, and the electrode tab 114 exposed to the outside the case 120 may be on the first support 141 of the substrate tab 140. More specifically, the electrode tab 114 may be exposed on the first support region 141a of the first support 141.

Next, the substrate tab 140 may be bent to cooperatively hold the electrode tab 114. In a state where the electrode tab 114 is on the first support 141, the second support 142 may be bent toward the first support 141. In this case, the second support 142 may be bent such that guide portions respectively formed on a side and the other side of the substrate tab 140 correspond to each other. That is, the second support 142 may be bent toward the first support 141 such that the protruding portion 143 on the first support 141 and the accommodating portion 144 on the second support 142 correspond to each other.

In an embodiment, in an operation of bending the substrate tab 140, a position of the second support 142 may be determined to accommodate the protruding portion 143 in the accommodating portion 144, and then the second support 142 may be bent.

In an embodiment, the method may further include an operation of changing a position of the second support 142 to accommodate the protruding portion 143 in the accommodating portion 144 when lifting occurs in the second support 142 because the protruding portion 143 may not be accommodated in the accommodating portion 144 in a state of the second support 142 being bent.

In an embodiment, an operation of bending the substrate tab 140 may bend the substrate tab 140 to overlap the notch portions 145 to each other. That is, when the second support 142 may be bent with respect to the notch portion 145 to include the boundary between the first support 141 and the second support 142 and the second support 142 may be fully bent on the first support 141 so as to be parallel to the first support 141, the notch portions 145 on the first support 141 and the second support 142 may at least partially overlap each other. More preferably, the second support 142 may be bent such that the notch portions 145 on the first support 141 and the second support 142 completely match each other.

Next, the electrode tab 114 and the substrate tab 140 may be welded to each other. In a state where the first support 141, the electrode tab 114, and the second support 142 may be sequentially arranged in a height direction, welding may be performed from the top surface of the second support 142 to connect the electrode tab 114 to the substrate tab 140. In an embodiment, welding may be laser welding.

As such, the disclosure has been described with reference to the embodiments shown in the drawings, but this is merely an example. It would be fully understood by those of ordinary skill in the art that various modifications and other equivalent embodiments are possible from the embodiments. Therefore, the true technical scope of the disclosure should be defined by the appended claims.

Specific technical details described in the embodiments are examples, and do not limit the technical scope of the embodiments. In order to briefly and clearly describe the description of the disclosure, the description of conventional general techniques and configurations may be omitted. Connections of lines or connection members between components shown in the drawings are illustrative of functional connections and/or physical or circuit connections, and in practice, may be expressed as alternative or additional various functional connections, physical connections, or circuit connections. In addition, when there is no specific mentioning, such as “essential” or “important”, it may not be a necessary component for the application of the disclosure.

A designator “the” or similar designators described in the description and the claims may refer to both singular and plural, unless otherwise specifically limited. In addition, when the range is described in the embodiment, the range includes the disclosure to which an individual value falling within the range is applied (unless stated otherwise), and is the same as the description of an individual value constituting the range in the description of the disclosure. When there is no apparent description of the order of operations constituting the method according to the embodiments or a contrary description thereof, the operations may be performed in an appropriate order. However, the disclosure is not necessarily limited according to the describing order of the operations. The use of all examples or exemplary terms (e.g., etc.) in the disclosure are to simply describe the disclosure in detail, and unless the range of the disclosure is not limited by the examples or the exemplary terms unless limited by the claims. In addition, it may be understood by those of ordinary skill in the art that various modifications, combinations, and changes may be made according to design conditions and factors within the scope of the appended claims or equivalents thereof.

The battery pack and the method of manufacturing the same according to an embodiment may satisfactorily connect the electrode tab to the protection circuit by using the substrate tab. In particular, the battery pack may securely determine a bending position of the electrode tab while satisfactorily and cooperatively holding the electrode tab by using the guide portion in the substrate tab. In this way, the operator may easily identify the bent state of the substrate tab and the position and the state in which the electrode tab cooperatively holds the electrode tab, and perform a welding process after the identification, thereby securing the reliability of connection between the electrode tab and the protection circuit.

By way of summation and review, a battery pack in which a position of a tab of a substrate may be guided in bending of the tab, and a method of manufacturing the battery pack is disclosed.

In this case, when the electrode assembly is overcharged above a protection voltage or discharged to an excessively low voltage, or when an overcurrent or an external load short-circuit occurs due to a device malfunction or an external shock, a damage may occur in the battery pack. Depending on the case, as gas may leak from the inside and heat may be generated without stopping at deformation, swelling or explosion may occur.

To prevent this problem, the battery pack may include a protection circuit to protect against overcharging and overdischarging, prevent an overcurrent, and protect against short-circuiting. The protection circuit may be connected to an electrode tab of an electrode assembly through welding, a tape, or other mechanical clamping members.

Meanwhile, as the area and thickness of portable electronic devices such as laptops, tablets, or smart phones, have decreased, battery packs are becoming miniaturized. In particular, as the area of a connection unit between an electrode assembly and a protection circuit is gradually decreasing, slight misalignment of a position of the connection unit may cause a significant problem in the reliability of the connection unit.

One or more embodiments include a battery pack capable of ensuring a good connection between an electrode tab of an electrode assembly and a protection circuit, and a method of manufacturing the battery pack.

Additional aspects will be set forth in part in the description and, in part, will be apparent from the description, or may be learned by practice of the presented embodiments of the disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack comprising a case, an electrode assembly accommodated in the case and including an electrode tab, and a protection circuit including a substrate tab connected to the electrode tab, wherein the substrate tab includes:
a first support on a top surface of the protection circuit,
a second support bendable with respect to the first support to cooperatively hold the electrode tab between the first support and the second support, and
a guide portion guiding a bending position of the second support.

2. The battery pack as claimed in claim 1, wherein the guide portion includes a protruding portion in any one of the first support and the second support and an accommodating portion in the other of the first support and the second support to accommodate the protruding portion.

3. The battery pack as claimed in claim 2, wherein the accommodating portion is recessed concavely on an inner side of the second support such that the protruding portion is not exposed to the outside in a state of being inserted into the accommodating portion.

4. The battery pack as claimed in claim 2, wherein a top surface of the protruding portion is exposed through the second support and where the protruding portion is inserted into the accommodating portion.

5. The battery pack as claimed in claim 4, wherein the protruding portion includes a proximal portion extending from the first support and a distal portion exposed through the second support and having an area greater than an area of the proximal portion.

6. The battery pack as claimed in claim 5, wherein the distal portion has an area greater than an area of the accommodating portion.

7. The battery pack as claimed in claim 6, wherein at least a part of the distal portion contacts a top surface of the second support in a state where the distal portion is forcedly inserted into the accommodating portion.

8. The battery pack as claimed in claim 2, wherein:
the first support includes a first region where the electrode tab is arranged and a second region outside the first region and in which the protruding portion is formed, and
the accommodating portion is outside the second support to correspond to the protruding portion.

9. The battery pack as claimed in claim 8, wherein the protruding portion includes a plurality of protruding portions which are separated from one another.

10. The battery pack as claimed in claim 8, wherein:
the first support includes a third region inside the second region adjacent to the second support, and
the protruding portion is in the third region.

11. The battery pack as claimed in claim 2, wherein the protruding portion protrudes above the electrode tab placed on the first support.

12. The battery pack as claimed in claim 1, wherein the support tab further includes a notch portion between the first support and the second support to include a boundary between the first support and the second support.

13. The battery pack as claimed in claim 1, wherein the protection circuit includes a nesting groove recessed in a top surface thereof such that the first support is placed in the nesting groove.

14. A method of manufacturing a battery pack, the method comprising:
arranging an electrode assembly including an electrode tab on an inner space of a case;
arranging the electrode tab on a substrate tab of a protection circuit;
bending the substrate tab such that guide portions on a side and another side of the substrate tab correspond to each other, so as to cooperatively hold the electrode tab with the substrate tab; and
welding the electrode tab and the substrate tab to each other.

15. The method as claimed in claim 14, wherein:
the substrate tab includes a first support placed on the protection circuit and a second support bendable with respect to the first support,
the guide portion includes a protruding portion on the first support and an accommodating portion on the second support to correspond to the protruding portion, and
the bending of the substrate tab includes determining a position of the second support and bending the substrate tab such that the protruding portion is accommodated in the accommodating portion.

16. The method as claimed in claim 15, wherein the welding includes performing welding on a region where the first support, the electrode tab, and the second support overlap one another.

17. The method as claimed in claim 15, wherein:
the substrate tab further includes a notch portion having a boundary between the first support and the second support, and
the bending of the substrate tab includes bending the substrate tab such that north portions on the first support and the second support overlap each other.

18. The method as claimed in claim 14, wherein the welding includes laser welding.
